(19) United States
(12) Patent Application Publication
(10) Pub. No.: US 2006/0040779 A1
(43) Pub. Date: Feb. 23, 2006

(54) Planetary reduction mechanism, pin structure, and method for manufacturing pin

(75) Inventors: Yo Tsurumi, Chiryu-shi (JP); Takashi Haga, Ohbu-shi (JP); Jun Tamenaga, Ohbu-shi (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Sumitomo Heavy Industries, Ltd.

(21) Appl. No.: 11/205,048

(22) Filed: Aug. 17, 2005

(30) Foreign Application Priority Data
Aug. 20, 2004 (JP) 2004-241563

(51) Int. Cl. F16H 13/06

(52) U.S. Cl. 475/183

(57) ABSTRACT

A planetary reduction mechanism includes a ring member and a planetary rotary member internally meshing with the internal gear, and a pin. The pin extends through the planetary rotary member for preventing orbital motion or rotation of the planetary rotary member, or for taking out an orbital motion component or a rotational component thereof. A continuous groove is formed on an outer circumference of the pin.

### BACKGROUND OF THE INVENTION

1. Field of the Invention

The present invention relates to a planetary reduction mechanism, a pin structure, and a method for manufacturing a pin used in the planetary reduction mechanism.

2. Description of the Related Art

An oscillatingly internally meshing planetary gear reduction mechanism is widely known. The mechanism includes an internal gear and an external gear that internally meshes with the internal gear while oscillatingly moves. The mechanism prevents rotation of the external gear or takes out a rotational component thereof via an inner pin extending through the external gear.

U.S. Pat. No. 4,898,065 discloses a planetary gear reducer device having a structure shown in FIGS. 4 and 5.

The planetary gear reducer device 10 includes an input shaft 12, an eccentric body 14, two external gears 16 (16A and 16B), an internal gear 18 with which the external gears 16 internally mesh, and an output shaft 22 as main components.

Each external gear 16 is provided with inner pin holes 30 extending through the external gear 16. An inner pin 40 is loosely fitted into each inner pin hole 30, and is pressed into and fixed to an inner-pin retention hole 22B of a flange portion 22A of the output shaft 22. An inner roller 42 serving as a sliding facilitation member is arranged outside the inner pin 40. The external gear 18 is formed integrally with a casing 11.

When a motor (not shown) rotates the input shaft 12, the eccentric body 14 is rotated with the rotated input shaft 12. Since an outer circumference of the eccentric body 14 is eccentric with respect to a shaft center of the input shaft 12, one rotation of the input shaft 12 causes the external gear 16 mounted around the eccentric body 14 to oscillatingly rotate. Thus, the external gear 16 relatively rotates with respect to the internal gear 18 by the amount corresponding to a difference of the number of teeth between the internal gear 18 and the external gear 16. That relative rotation is taken out to the flange portion 22A of the output shaft 22 through the inner pin holes 30, the inner rollers 42, and the inner pins 40.

An oscillating component of the external gear 16 is absorbed by loose fitting of the inner pins 40 (inner pin rollers 42) and the inner pin holes 30. Thus, speed reduction can be achieved at a reduction ratio corresponding to a value of (the difference of the number of teeth between the internal gear 18 and the external gear 16)/(the number of teeth of the external gear 16).

In order to smoothly take out the rotational component of the external gear 16, a sliding manner between each of a plurality of inner pin holes 30 and a corresponding inner pin 40 has to be completely coincident with each other. Thus, it is necessary to process and fabricate loose fitting of the inner pin hole 30 and the inner pin 40 (inner roller 42) with very high precision. From this reason, a fabrication method has been conventionally employed, in which the inner pin 40 is processed and polished with high precision separately from the inner-pin retention hole 22B formed in the flange portion 22A with high precision, and is then pressed into the inner-pin retention hole 22B.

A lubricant such as grease is put in the casing 11 so as to facilitate slidablity of respective parts.

This type of planetary reduction mechanism has a problem that the lubricant such as grease is not sufficiently supplied to a sliding surface of the inner pin although the lubricant is put in the casing in order to facilitate the slidability of the respective parts. That is, the lubricant does not fulfill its function. This problem tends to become more apparent in an arrangement in which the sliding facilitation member such as the inner roller is arranged around the inner pin as in the above conventional example. However, when a gap between the inner pin and the inner roller is made larger in order to make entering of grease to the sliding surface easier, for example, this causes eccentric movement of the inner roller with respect to the inner pin, thus increasing a noise and transmission loss.

### SUMMARY OF THE INVENTION

In view of the above problems in the conventional techniques, various exemplary embodiments of the present invention provide a structure of a pin extending through a planetary rotary member of the aforementioned type of planetary reduction mechanism and a method for manufacturing that pin, which can improve the basic quality or performance.

To achieve the above object, the present invention, a structure of a pin of a planetary rotary member of a planetary reduction mechanism (or a method for fabricating the pin) is provided. The planetary reduction mechanism includes a ring member and the planetary rotary member internally meshing with the ring member, and prevents orbital motion or rotation of the planetary rotary member or takes out an orbital motion component or a rotational component thereof via the pin extending through the planetary rotary member. In the structure of the pin, a continuous groove is formed on an outer circumference of the pin. In the manufacturing method, formation of the continuous groove on the outer circumference of the pin is included.

According to the present invention, the “continuous groove” is formed on the outer circumference of the pin extending through the planetary rotary member. Thus, it is possible to efficiently supply a lubricant such as grease or lubricating oil that exist around the pin of the planetary rotary member to an engaging surface of the pin and the planetary rotary member. This enables smooth sliding of the pin and the planetary rotary member with respect to each other. Since the continuous groove is continuously formed on the outer circumference of the pin literally, the lubricant entering the groove can be efficiently moved in an axial direction even if the lubricant enters the groove from any portion.

Consequently, favorable sliding property can be obtained only by performing a simple process for the outer circumference of the pin, and the inner pin that can slide more smoothly and has a longer life can be obtained.

The “outer circumference of the pin extending through the planetary rotary member” in the present invention shall include all of the following four embodiments.

1) The outer circumference of the pin in the case where the planetary rotary member is directly engaged with the pin.

2) The outer circumference of the pin in the case where a sliding facilitation member is provided outside the pin and the planetary rotary member is engaged with the sliding facilitation member.

3) An outer circumference of the sliding facilitation member in the case where the facilitation member is provided outside the pin and the planetary rotary member is engaged with the sliding facilitation member.

4) The outer circumferences of both the pin and the sliding facilitation member in the case where the sliding facilitation member is provided outside the pin and the planetary rotary member is engaged with the sliding facilitation member.

In any of the above embodiments, an effective lubricating effect can be achieved for at least one of a sliding surface between the pin and the planetary rotary member, a sliding surface between the pin and the sliding facilitation member, and a sliding surface between the sliding facilitation member and the planetary rotary member.

As described above, the present invention can improve the basic quality or performance related to the inner pin only by performing a simple process.

### BRIEF DESCRIPTION OF THE DRAWINGS

FIG. 1 is a vertical cross-sectional view of a planetary gear reducer device to which an exemplary embodiment of the present invention is applied;

FIG. 2 schematically shows outside-diameter machining performed for an outer circumference of an inner pin integrated with a first supporting flange to process that outer circumference;

FIG. 3 is a cross-sectional view showing a part of an outer circumferential surface of the inner pin in an enlarged state in case of performing a surface hardening process and a roller vanishing process after a spiral groove is formed;

FIG. 4 is a vertical cross-sectional view showing an exemplary conventional planetary gear reducer device; and

FIG. 5 is a cross-sectional view of the conventional planetary gear reducer device, taken along the line V-V in FIG. 4.

### DETAILED DESCRIPTION OF PREFERRED EMBODIMENTS

Preferred exemplary embodiments of the invention will be hereinafter described with reference to the drawings.

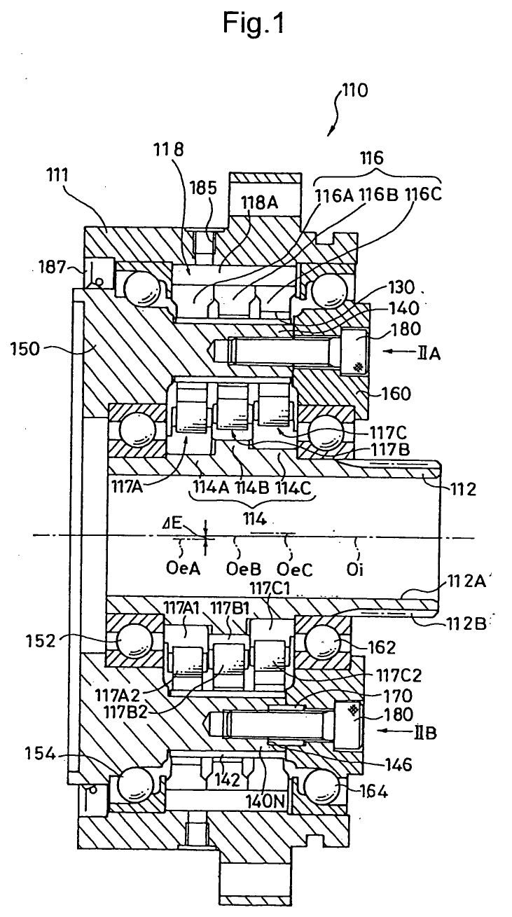

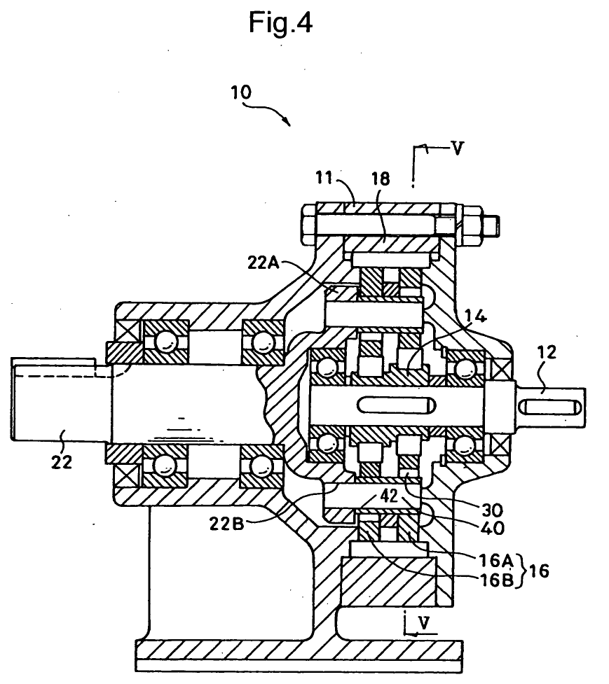

FIG. 1 is a vertical cross-sectional view corresponding to FIG. 4. FIG. 1 shows a planetary gear reducer device having an inner pin fabricated by “a method for fabricating a pin of a planetary rotary member of a planetary reduction mechanism” according to an embodiment of the present invention.

The planetary gear reducer device 110 includes an input shaft 112, an eccentric body 114, three external gears (planetary rotary members) 116, an internal gear (ring member) 118, and an output shaft (150) as main components. A first supporting flange (=carrier) 150 and a second supporting flange 160 are provided on both sides of the external gear 116 in an axial direction. In this exemplary embodiment, the first supporting flange 150 serves as the output shaft.

The input shaft 112 is supported at its ends by bearings 152 and 162 respectively incorporated into the first and second supporting flanges 150 and 160 so as to be freely rotatable. The input shaft 112 has a hollow portion 112A having a large diameter at its center (i.e., hollow structure) and is connected to a motor shaft of a motor (not shown) through a spline 112B.

The eccentric body 114 is molded integrally with the input shaft 112. The eccentric body 114 includes three eccentric portions 114A to 114C that correspond to axial positions of the three external gears 116, respectively. Centers OeA to OeC of outer circumferences of the eccentric portions 114A to 114C are eccentric with respect to a shaft center Oi of the input shaft 112 by ΔE. Eccentric phases of the respective eccentric portions 114A to 114c are different from each other by 120 degrees.

The three external gears 116 (116A to 116C) are mounted on the eccentric portions 114A to 114C of the eccentric body 114 through bearings 117A to 117C, respectively, so as to be freely rotatable. The bearings 117A to 117C only include inner rings 117A1 to 117C1 and rollers 117A2 to 117C2, respectively. Outer rings of the bearings 117A to 117C are integrated with the corresponding external gears 116A to 116C, respectively. That is, the external gears 116A to 116C also serve as the outer rings of the corresponding bearings 117A to 117C. The positioning of the bearings 117A to 117C in the axial direction is achieved by the bearings 152 and 162 that support the input shaft 112.

The three external gears are arranged in parallel in the axial direction in order to increase a transmission capacity. Each external gear 116 has inner pin holes 130 extending through that external gear 116.

The internal gear 118 is integrated with a casing 111 of the planetary gear reducer device 110. The casing 111 is fixed to a member outside the planetary gear reducer device 110 in this exemplary embodiment. More specifically, an internal tooth 118A of the internal gear 118 is formed by a roller-like pin.

The first supporting flange 150 and the second supporting flange 160 are supported by the casing 111 through bearings 154 and 164, respectively, so as to be freely rotatable. External equipment (not shown) that is to be driven can be connected to the first supporting flange 150 by using a bolt or the like (not shown). The first supporting flange 150 has inner pins 140 (pins extending through the planetary rotary member) that are integrated therewith (as portions of the first supporting flange 150).

An inner roller (sliding facilitation member) 142 is mounted on an outer circumference of each inner pin 140 to be freely rotatable. That is, the inner pin holes 130 and the inner pins 140 transmit a power through the inner rollers 142 specifically. In the case where the internal gear 118 is fixed as in the present exemplary embodiment, a rotational component of the external gear 116 is taken out through the inner pins 140.

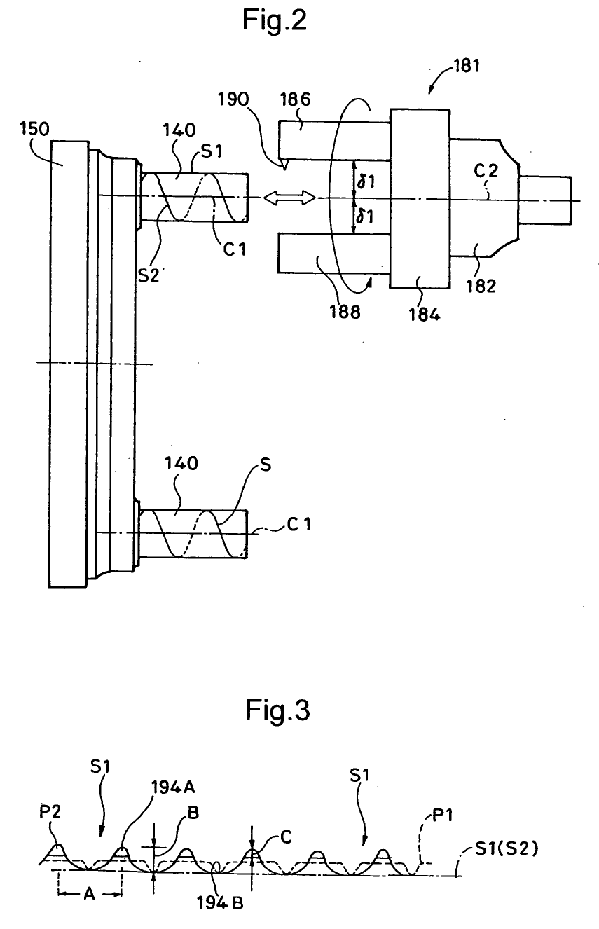

In the present exemplary embodiment, the first supporting flange 150 and the (original) inner pins 140 are molded integrally with each other, as shown in FIG. 2. Post-processing of the inner pin 140 is performed by a machine tool called as an “outside-diameter machining device,” for example. The outside-diameter machining device 181 includes as main components a rotary head 182, an offsetter 184 integrated with the rotary head 182, and a pair of cylindrical bodies 186 and 188 attached to the offsetter 184. A bite chip 190 for cutting is attached to one cylindrical body 186. The other cylindrical body 188 serves as a balance weight. Since the offsetter 184 is integrated with the rotary head 182, the offsetter 184 can be rotated around an axial line C2 that is coincident with an axial line C1 of the inner pin 140. The rotary head 182 can move back and forth along the axial line C1 (C2) together with the offsetter 184 and the cylindrical bodies 186 and 188. The two cylindrical bodies 186 and 188 are arranged in such a manner that their attachment positions on the offsetter 184 can be moved on a sliding base (not shown), thereby allowing adjustment of an offset amount 61 of both the cylindrical bodies 186 and 188 from the axial line C1 (C2) to be performed.

A “continuous groove” S1 formed on the outer circumference of the inner pin 140 is a spiral groove formed in forward processing, i.e., a process in which the bite chip 190 of the outside-diameter machining device 181 performs cutting while moving forward in this exemplary embodiment. A spiral groove S2 is formed by a path of the bite chip 190 on the outer circumference of the inner pin 140 when the outside-diameter machining device 181 is pulled out in a final stage of processing of the outer circumference of the inner pin 140 by the outside-diameter machining device 181 (i.e., in a so-called return process). In the present exemplary embodiment, this spiral groove S2 is also used as a “continuous groove.”

Returning to FIG. 1, holes 146 are formed at ends of one or more of a plurality of inner pins 140 (several inner pins 140N in this exemplary embodiment), respectively. A knock pin 170 that is a pipe-like part is knocked in each hole 146 from the side of the second supporting flange 160. A connecting bolt 180 is screwed into an end of every inner pin 140 including the inner pin 140N in which the knock pin 170 is knocked, from the side of the second supporting flange 160. In the inner pin 140N in which the knock pin 170 is knocked, the connecting bolt 180 is screwed into the inner pin 140N while extending through the knock pin 170.

In the planetary gear reducer device 110, a port 185 for putting grease as lubricant in the casing 111 and a seal member 187 are provided. Only one seal member 187 is provided in the present embodiment, considering the viscosity of the grease or the like.

Next, an operation of the planetary gear reducer device 110 is described.

When the input shaft 112 is rotated by rotation of a motor shaft (not shown), the eccentric body 114 integrated with the input shaft 112 is rotated. The outer circumference of the eccentric body 114 is eccentric with respect to the shaft center Oi of the input shaft 112 by ΔE. Thus, three external gears 116 are oscillatingly rotated by the rotation of the eccentric body 114 through the bearings 117A to 117C with a phase difference of 120 degrees therebetween, while internally meshing with the internal gear 118. In this example, the internal gear 118 is integrated with the casing 111 and is fixed to an external member. Therefore, when one revolution of the input shaft 112 causes the external gear 116 to oscillartingly rotate, the external gear 116 relatively rotates with respect to the internal gear 118 (i.e., makes autorotation) by the amount corresponding to a difference of teeth between the gears 116 and 118.

The relative rotation (rotational component) of the external gears 116 is taken out to the first and second supporting flanges 150 and 160 through the inner pin holes 130, the inner rollers 142, and the inner pins 140. The oscillating components of the external gears 116 are absorbed by loose fitting of the inner holes 130 and the inner pins 140 (inner rollers 142). Thus, a reduction ratio corresponding to the value of (a difference of the number of teeth between the internal gear 118 and the external gears 116)/(the number of teeth of the external gears 116) can be achieved by only one stage.

In the planetary gear reducer device 110 of the present exemplary embodiment, the first supporting flange 150 is connected to external equipment (not shown) that is to be driven by means of a bolt or the like (not shown). Therefore, the external equipment can be driven via the first supporting flange 150.

The first supporting flange 150 may be fixed so as to use the casing 111 itself as an output member (this arrangement is called as a frame rotary arrangement). In this case, the aforementioned inner pins 140 (and the inner rollers 142) provide a function of restricting rotation of the external gear (planetary rotary member) 116.

Since the inner pins 140 are molded integrally with the first supporting flange 150 from the beginning, the number of parts can be largely reduced. Moreover, it is unnecessary to form inner-pin retention holes in the first supporting flange 150 with high precision and to press the separate inner pins 140 into such inner-pin retention holes. Therefore, the cost can be largely reduced.

In the present exemplary embodiment, there is a spiral groove S1 on the outer circumference of the inner pin 140, which is a first continuous groove formed in the forward-processing, i.e., the process in which the bite chip 190 of the outside-diameter machining device 181 performs cutting while moving forward. In addition, a spiral groove S2 (that is a second continuous groove) is also formed on the outer circumference of the inner pin 140 in the return process after the forward-processing by the outside-diameter machining device 181 is finished.

Due to the spiral grooves S1 and S2, even if grease having approximately the same viscosity as that used conventionally is used, the grease can be supplied well to a sliding surface formed by the outer circumference of the inner pin 140 and an inner circumference of the inner roller 142.

Especially, the spiral groove S2 can further improve flowing efficiency of the lubricant because it crosses the spiral groove S1 diagonally in a transverse direction.

Thus, even if the inner roller 142 is mounted on the inner pin 140 with almost no gap therebetween, the inner roller 142 is allowed to very smoothly rotate around the inner pin 140. That is, a power is smoothly transmitted from the external gear 116 to the first supporting flange 150 that integrally supports the inner pin 140 via the inner pin holes 130, the inner rollers 142, and the inner pin 140. Consequently, the basic performance can be kept high while the cost is reduced.

Moreover, the second supporting flange 160 that connects the ends of the respective inner pins 140 to each other is arranged at the ends of the respective pins 140. Thus, high supporting rigidity can be ensured and “deviation” of the inner pins 140 during operation hardly occurs. The supporting rigidity lowers little with the time.

When the inner pins 140 and the second supporting flange 160 are connected to each other, highly precise positioning can be achieved by knocking the knock pin 170. Connection stress between the inner pins 140 and the second supporting flange 160 is ensured by a frictional force between the inner pins 140 and the second supporting flange 160 generated by a connection force of the connecting bolt 180 (and shearing stress of the knock pin 170). That is, the connection stress between the inner pins 140 and the second supporting flange 160 does not rely on shearing stress of the inner pins inserted in the second supporting flange, for example. Therefore, it is not necessary to form the same number of inner-pin retention holes as the inner pins 140 with high precision in the second supporting flange 160. In addition, it is possible to prevent application of a local shearing load to the inner pins 140.

The knock pin 170 is hollow. This allows the connecting bolt 180 to be screwed into the inner pin 140N in which the knock pin 170 is knocked. Thus, rigid connection can be achieved between the second supporting flange 160 and the inner pins 140.

In the above exemplary embodiment, a structure is described in which a sliding facilitation member (inner roller) is arranged around the inner pin. However, the sliding facilitation member is not always essential in the present invention. Even in the case where no sliding facilitation member is used, better supply of lubricant to a sliding point (sliding line) at which the inner pin and the inner pin hole of the external gear slide with respect to each other can be achieved by forming a continuous groove on the outer circumference of the inner pin, as compared with the conventional technique.

On the other hand, in case of employing the structure in which the sliding facilitation member is mounted around the inner pin, the continuous groove may be formed only on the outer circumference of the inner pin as in the above exemplary embodiment. Alternatively, the continuous groove may be formed on the outer circumference of the inner roller, instead of the outer circumference of the inner pin. In this case, better supply of lubricant to a sliding point (sliding line) at which the inner roller and the inner pin hole slide with respect to each other can be achieved as compared with the conventional technique, although supply of lubricant to a sliding surface between the inner pin and the inner roller is the same as that in the conventional technique. Alternatively, the continuous grooves may be formed on both the outer circumference of the inner pin and the outer circumference of the inner roller. All of those cases fall within the scope of exemplary embodiments of the present invention. As the sliding facilitation member, a bearing or the like can be used other than the aforementioned inner roller.

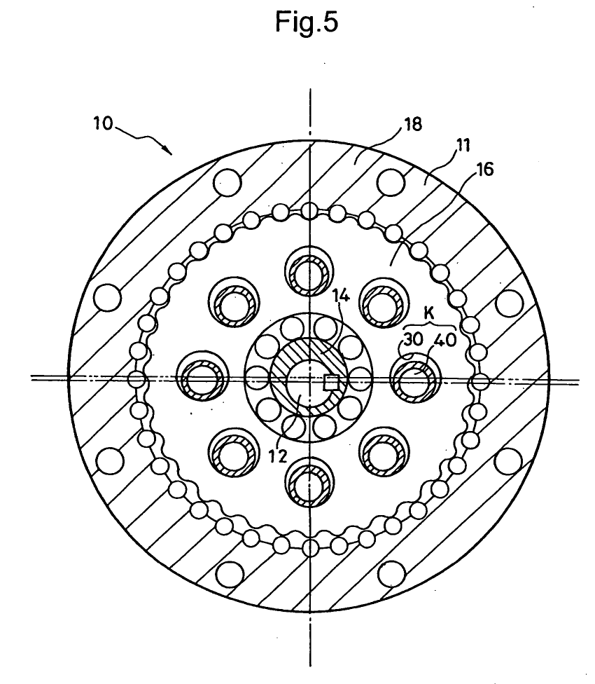

In the above exemplary embodiment, the inner pins are integrated with the first supporting flange. Alternatively, inner pins (with continuous grooves formed thereon, respectively) that are formed separately from the first supporting flange may be pressed into a plurality of inner-pin retention holes formed in the first supporting flange, as in the conventional example described referring to FIGS. 4 and 5, for example.

The second supporting flange in the above exemplary embodiment is not always essential. For example, a cantilever inner pin may be employed, as shown in FIGS. 4 and 5.

In the above embodiment, two types of continuous grooves S1 and S2 are formed on the outer circumference of the pin. In the present invention, a specific method for forming the continuous groove is not limited thereto. For example, in case of fabricating the inner pin separately from the first supporting flange as in the conventional technique, the continuous groove may be formed by a cutting groove formed when the outer diameter of the inner pin is processed by a turning machine.

After formation of the continuous groove, when a roller vanishing process is performed (in such a manner that the formed continuous groove remains), a convex portion (top portion) 194A of the fine continuous groove (cutting groove) S1 (or S2) that is formed by outside-diameter machining or turning can be pressed and be subjected to plastic working, as shown in FIG. 3. Thus, it is possible to form a smooth surface P1 that is extremely smooth on the outer circumference of the inner pin, in addition to the continuous groove S1 or S2. In this case, the effect of the continuous groove S1 (S2) can be achieved at the same time.

A surface hardening process such as a radio frequency treatment or a nitriding treatment may be performed before the roller vanishing process. Thus, it is possible to effectively prevent a convex portion (bottom portion) 194B of the continuous groove S1 (S2) formed by outside-diameter machining or turning from being mostly filled with a material while achieving a mirror-finishing effect of roller vanishing. The material is a material of a portion corresponding to the convex portion 194A that is flattened by the roller vanishing process. Namely, the smooth surface P2 can be formed with the continuous groove S1 (S2) kept. Moreover, when cutting is first performed to achieve a diameter of the pin that is approximately the same as a desired diameter and thereafter roller vanishing is performed to achieve that desired diameter, the precision of the outer diameter of the pin can be further improved.

FIG. 3 schematically shows a shape of an outer circumferential surface of the inner pin 140. On that outer circumferential surface, a pitch A of the continuous groove S1 is about 30 to about 200 μm and a height (depth) B of the continuous groove S1 (S2) is about 3 to about 10 μm, for example. A height of the part of the convex portion (top portion) that is cut by the surface hardening process and the roller vanishing process is about 2 to about 6 μm.

The present invention can be applied not only to an oscillatingly internally meshing planetary gear reduction mechanism as described in the above exemplary embodiment but also to a simple planetary gear reduction mechanism, for example. In case of the simple planetary gear reduction mechanism, a pin extending through a planetary gear (planetary rotary member) has a function of preventing orbital motion of the planetary gear or taking out an orbital motion component. However, the same operation and effects as those in the above exemplary embodiment can be achieved with regard to formation of a continuous groove on an outer circumference of that pin.

Moreover, the present invention can be applied not only to a planetary reduction mechanism in which gears mesh with each other but also to a traction drive type planetary reduction mechanism in which rollers roll. In both cases, the same effects as those in the above exemplary embodiment can be achieved.

The continuous groove may not be continuous from one end of the pin to the other end. The continuous groove may be formed only on a part of the pin (e.g., on a portion corresponding to the width of the planetary rotary member).

It is not necessary that a plurality of types of grooves are always formed. For example, only the continuous groove (spiral groove) S1 may be formed by performing outside-diameter machining from the first supporting flange side toward the end of the inner pin.

In addition, a plurality of relatively short continuous grooves may be formed.

The present invention can be applied to the technical field in which this type of planetary reduction mechanism has been conventionally employed. In fact, since higher performance can be ensured without largely increasing the cost, it is expected that application of the present invention is further expanded.

The disclosure of Japanese Patent Application No. 2004-241563 filed Aug. 20, 2004 including specification, drawing and claim are incorporated herein by reference in its entirety.

What is claimed is:

1. A planetary reduction mechanism comprising:
a planetary rotary member;
a ring member with which the planetary rotary member internally meshes or contacts; and
a pin extending through the planetary rotary member for preventing orbital motion or rotation of the planetary rotary member, or for taking out an orbital motion component or a rotational component thereof; wherein
a continuous groove is formed on an outer circumference of the pin.

2. The planetary reduction mechanism according to claim 1, wherein
the continuous groove and a surface processed by a vanishing process are formed on the outer circumference of the pin.

3. A pin structure of a planetary reduction mechanism, the planetary reduction mechanism having a carrier, wherein
the pin is integrated with the carrier as a portion of the carrier, and
a continuous groove is formed on an outer circumference of the pin.

4. A method for manufacturing a pin of a planetary reduction mechanism, the planetary reduction mechanism comprising a planetary rotary member, a ring member with which the planetary rotary member internally meshes or contacts, and the pin extending through the planetary rotary member for preventing orbital motion or rotation of the planetary rotary member, or for taking out an orbital motion component or a rotational component thereof, the method including steps of:
manufacturing a original of the pin, and
forming a continuous groove on an outer circumference of the original.

5. The method for manufacturing a pin of a planetary reduction mechanism according to claim 4, wherein
the step of forming the continuous groove includes a machining step to process the outer circumference of the pin.

6. The method for manufacturing a pin of a planetary reduction mechanism according to claim 5, wherein
the machining step includes a forward-processing step and a return step, and different continuous grooves are formed in the forward-processing step and the return step, respectively.

7. The method for manufacturing a pin of a planetary reduction mechanism according to claim 4, wherein
the step of forming the continuous groove includes a turning step to process the outer circumference of the original, and a cutting groove formed by the turning step forms the continuous groove.

8. The method for manufacturing a pin of a planetary reduction mechanism according to claim 4, further comprising a vanishing step to process the outer circumference of the pin in such a manner that the continuous groove remains, after the step of forming the continuous groove.

9. The method for manufacturing a pin of a planetary reduction mechanism according to claim 8, further comprising a surface hardening step to process the outer circumference of the pin between the step of forming the continuous groove and the vanishing step.
